(19) United States
(12) Patent Application Publication
(10) Pub. No.: US 2009/0077034 A1
(43) Pub. Date: Mar. 19, 2009

(54) Personal ordered multimedia data service method and apparatuses thereof

(75) Inventors: Nac Woo Kim, Seoul (KR); Jae Hun Kim, Jeollabuk-do (KR); Il Kyun Park, Seoul (KR); Ho Young Song, Daejeon (KR); Bong Tae Kim, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics & Telecmommunications Research Institute

(21) Appl. No.: 12/157,065

(22) Filed: Jun. 6, 2008

(30) Foreign Application Priority Data
Sep. 19, 2007 (KR) 10-2007-0095519

(51) Int. Cl. G06F 7/06; G06F 17/30

(52) U.S. Cl. 707/3; 707/E17.014

(57) ABSTRACT

A personal-ordered multimedia data search service method and apparatuses thereof are provided. The apparatus includes: a server which extracts feature information and meta data of entire screen or partial region of each scene-image of multimedia to generate image index information, and then obtains and provides search result images and meta data having feature information similar to feature information of image query information by searching the image index information, when image query information is received; and a set-top box which plays multimedia, wherein when a user issues a request for searching an arbitrary for the playing multimedia, the set-top box extracts feature information of the entire or partial region of the image to generate the image query information and transmits the image query information requesting for searching the image by using the extracted feature information to the server, and after that, when the search result images and meta data are provided from the server, browses the search result images and meta data on a display apparatus. Accordingly, it is possible to maximize user's satisfaction in searching for multimedia data.

### CROSS-REFERENCE TO RELATED APPLICATIONS

This application claims the priority of Korean Patent Application No. 10-2007-0095519 filed on Sep. 19, 2007, in the Korean Intellectual Property Office, the disclosure of which is incorporated herein by reference.

### BACKGROUND OF THE INVENTION

1. Field of the Invention

The present invention relates to a personal-ordered multimedia data search service method and apparatuses thereof, and more particularly, to a personal-ordered multimedia data search service method and apparatuses thereof in which a set-top box searches for scene or object information search-requested by a user during watching moving picture in cooperation with a connected server and provides the searched scene or object information to the user.

2. Description of the Related Art

In general, a set-top box used as a terminal apparatus of a multimedia network connects digital/analog communication channels to a multimedia apparatus of a user to enable the user to watch digital broadcasting.

The set-top box provides video-on-demand (VoD) service, a cable TV (CATV) service, a satellite broadcasting service, and a terrestrial broadcasting service to the user so that the user can watch a desired image data at a desired time in real-time.

Recently, as devolvement of a wideband network, a large number of users create and uses high-quality multimedia contents.

In the convention set-top box, if the user during watching moving picture such as VoD desires to know detail information on a product, a person, a location, or the like, the user stops watching the moving picture to search for the information by using a separate PC or an explorer on the set-top box.

However, in case of image contents that the user desires to know, in the conventional information searching method, the user cannot remind the image contents and directly use the image contents for image search query. In the information searching method, since the user cannot know meta data information of the image, keyword search using the meta data is not available.

### SUMMARY OF THE INVENTION

The present invention provides a personal-ordered multimedia data search service method and apparatuses thereof in which a user desiring to know detail information of screen image during watching a VoD or the like can directly search and acquires a desired scene or object information on a watching program screen without stop watching the moving picture and searching for the information by using a separate PC or an explorer on a set-top box.

According to an aspect of the present invention, there is provided a set-top box for providing a personal-ordered multimedia data search service comprising: a data query unit which, if a user requests for searching an arbitrary scene-image during playing of multimedia, extracts feature information of the entire screen or partial region of the scene-image and generates image query information of requesting for searching an image by using the extracted feature information; a data selecting unit which browses search result images and meta data provided from a server corresponding to the image query information on a display apparatus, and plays the one image selected by the user among the browsed images; and a transceiver which communicates data with the server to transmit the image query information and receive the search result images and the meta data.

In the above aspect of the present invention, the data query unit comprises: an image acquisition unit which captures the entire screen of the image search-requested by the user and acquires an image of the captured entire screen or partial region of the captured entire screen as searched images; an image partitioning unit which partitions the entire screen or the partial region into object regions; and a feature extracting unit which extracts the feature information from the object regions and generates the image query information including the extracted feature information.

In addition, the feature information includes feature values of motions of object regions or the like.

In addition, the image acquisition unit provides a service of enabling the user to set region-partitioning points for identifying the partial region by using an interface apparatus, when the user acquires the partial region image in the captured screen image.

In addition, the image partitioning unit partitions the entire screen or the partial region into the object regions by using a predetermined image partitioning scheme or a matching scheme for region-partitioning points set by the user.

In addition, the data selecting unit comprises: an image browsing unit which re-constructs the search result images and the meta data provided from the server corresponding to the image query information to be data suitable for a configuration of the display apparatus and browses the search result images and the meta data on the display apparatus; an image selecting unit which checks an image selected by the user among the browsed images on the display apparatus; and a file playing unit which plays the image selected by the user.

According to a second aspect of the present invention, there is provided a server for providing a personal-ordered multimedia data search service comprises: a DB (database) which stores at least one multimedia and image index information on each scene-image of the multimedia; a DB constructing unit which detects scene-change boundaries and representative frames of scene-images of the multimedia and partitions each representative frame of the scene-images into a plurality of regions by using a predetermined region partitioning scheme, and extracts feature information and meta data from the representative frames and the partitioned regions to generate the image index information; a comparing/searching unit which, when the image query information is transmitted, acquires the image index information having the feature information included in the image query information by searching the DB and generates search result information including search result images and meta data based on the searched feature information; and a transceiver which communicates data with an external device to receive the image query information and transmit the search result information.

In the above aspect of the present invention, the DB constructing unit comprises: a scene change detecting unit which detects the scene-change boundaries between the images of the multimedia to partition the multimedia into small sized meaning groups of scene-images; a representative frame extracting unit which extracts the representative frames of the partitioned scene-images; a feature extracting unit which extracts the feature information and the meta data of the representative frames and the regions partitioned from the representative frames; and an image indexing unit which generates the image index information by using the feature information and the meta data.

In addition, the feature extracting unit sets the feature information of the representative frame of each scene-image as entire-region feature information and sets the feature information of the regions partitioned from the representative frame as partial-region feature information to generate and store the image index information in separation of the entire region and the partial regions.

In addition, the comparing/searching unit comprises: a data similarity comparing unit which compares the feature information of the image query information with the feature information of the image index information; and a search result generating unit which searches for the feature information of the image index information that is determined to be similar to the feature information of the image query information and generates the search result information including the search result images and the meta data corresponding to each of the searched feature information of the image index information.

According to a third aspect of the present invention, there is provided a personal-ordered multimedia data search service system, comprising: a server which extracts feature information and meta data of entire screen or partial region of each scene-image of multimedia to generate image index information and then obtains and provides search result images and meta data having feature information similar to feature information of image query information by searching the image index information, when image query information is received; and a set-top box which, if when a request for searching a specific image is detected during playing of multimedia, extracts feature information of the specific image to generate the image query information, transmits the image query information to the server, and after that, and browses the search result images and the meta data transmitted from the server on a display apparatus.

In the above aspect of the present invention, the set-top box comprises: a data query unit which, if a requests for searching an arbitrary scene-image during playing of multimedia is received, extracts the feature information of the entire screen or partial region of the arbitrary scene-image and generates the image query information of requesting for searching an image by using the extracted feature information; a data selecting unit which browses search result images and meta data provided from a server corresponding to the image query information on the display apparatus, and play one image selected by a user among the browsed images; and a transceiver which transmits the image query information to the server and receives the search result images and the meta data transmitted from the server to transfer the search result images and the meta data to the data selecting unit.

In addition, the server comprises: a DB (database) which stores the multimedia and the image index information on each scene-image of the multimedia; a DB constructing unit which extracts the feature information and the meta data from the entire screen or the partial regions of each scene-image of the multimedia to generate the image index information; a comparing/searching unit which, if the image query information is transmitted from the set-top box, acquires the image index information having the feature information included in the image query information by searching the DB and generates search result information including the search result images and the meta data based on the searched feature information; and a transceiver which communicates data with the set-top box to receive the image query information and transmit the search result information to an external apparatus.

According to a fourth another aspect of the present invention, there is provided a method of operating a set-top box for providing a personal-ordered multimedia data search service comprising steps of: extracting feature information of the entire screen or partial region of an arbitrary scene-image, when a request for searching the arbitrary scene-image during playing of multimedia is received; generating image query information of requesting for searching an image by using the extracted feature information and transmitting the image query information to the server; and browsing search result images and meta data on a display apparatus, when the search result images and the meta data corresponding to the image query information are received.

In the above aspect of the present invention, the step of extracting comprises steps of: capturing the entire screen of the arbitrary scene-image requested for searching; checking whether the partial region in the entire screen is set or not; setting the partial region as an searched image if the partial region is set and setting the entire screen as the searched image if not; partitioning the searched image into object regions; and extracting the feature information of the object regions.

In addition, the step of checking provides a setting environment of region-partitioning points for partitioning the partial region from the entire screen to a user in order to set the partial region.

In addition, the step of partitioning detects the object region from the entire screen or the partial region by using a predetermined image partitioning scheme or a matching scheme for region-partitioning points set by the user.

In addition, the step of browsing re-constructs the search result images and the meta data to be data suitable for a configuration of the display apparatus and browses the search result images and the meta data on the display apparatus.

According to a fifth aspect of the present invention, there is provided a method of operating a server for providing a personal-ordered multimedia data search service comprising steps of; extracting feature information and meta data from the entire screen or partial regions of each screen-image of multimedia and generating and storing image index information of each scene-image; receiving an image query information transmitted from an external device and then checking feature information included in the image query information; and searching feature information similar to feature information included in the image query information from the image index information, generating search result information including search result images and meta data corresponding to the searched feature information, and transmitting the search result information to the external device.

In the above aspect of the present invention, the step of generating and storing comprising steps of; detecting scene-change boundaries between images of the to multimedia to partition the multimedia into scene-images; extracting representative frames of the partitioned scene-images and the feature information and the meta data of regions obtained by partitioning each representative frame by using a predetermined region partitioning scheme; and generating and storing the image index information by using the extracted feature information and meta data.

In addition, the feature information of the representative frame of each scene-image is set as entire-region feature information, and the feature information of the regions partitioned from the representative frame is set as partial-region feature information, so that the image index information is separated into the entire region and the partial regions.

In addition, step of searching feature information similar to feature information included in the image query information from the image index information comprising; determining whether the arbitrary feature information is feature information of the entire screen or the partial regions; and searching for image index information of the entire region or the partial regions according to whether the feature information is feature information of the entire screen or the partial region so as to search for the feature information similar to the extracted feature information.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating a configuration of a personal-ordered multimedia data search service system according to an embodiment of the present invention;

FIG. 2 is a block diagram illustrating a set-top box of the personal-ordered multimedia data search service system according to the embodiment of the present invention;

FIG. 3 is a block diagram illustrating a server of the personal-ordered multimedia data search service system according to the embodiment of the present invention;

FIG. 4 is a flowchart illustrating a method of a set-top box providing a personal-ordered multimedia data search service according to an embodiment of the present invention;

FIG. 5 is a flowchart illustrating a method of a server constructing a database providing for a personal-ordered multimedia data search service according to an embodiment of the present invention;

FIG. 6 is a flowchart illustrating a method of a server providing a personal-ordered multimedia data search service according to an embodiment of the present invention;

FIG. 7 is a view illustrating an image screen for personal-ordered multimedia data search service which a set-top box provides to a display apparatus, according to an embodiment of the present invention; and

FIG. 8 is a view illustrating a screen of a display apparatus on which search result images and meta data provided from a sever are browsed according to an embodiment of the present invention.

### DETAILED DESCRIPTION OF THE PREFERRED EMBODIMENT

Hereinafter, embodiments of the present invention will be described in detail with reference to the accompanying drawings.

For clarifying the present invention, detailed description of well-known functions and constructions will be omitted.

In the drawings, elements having similar function and operations are denoted by the same reference numerals.

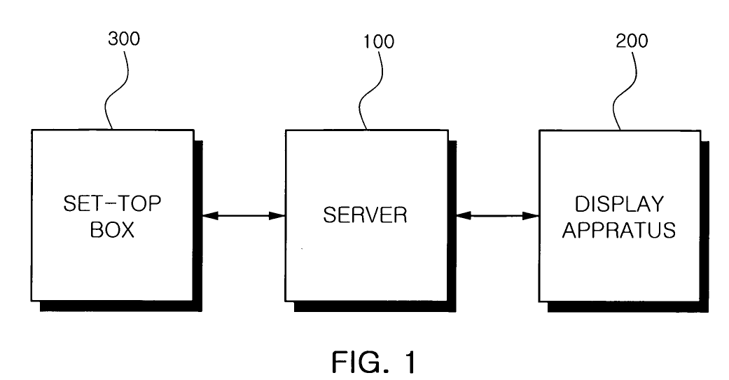

FIG. 1 is a view illustrating a configuration of a personal-ordered multimedia data search service system according to an embodiment of the present invention.

As shown in FIG. 1, the personal-ordered multimedia data search service system may include a set-top box 100, a server 200, and a display apparatus 300.

In the personal-ordered multimedia data search service system, the server 200 extracts feature information and meta data of scene-images or partial images of to-be-stored multimedia and, after that, generates and stores image index information by using the feature information and the meta data of the images. Next, when the remote set-top box 100 requests for searching the images for arbitrary feature information, the server 200 searches for feature information similar to the feature information of the search-requested image from the image index information and provides image and meta data corresponding to the searched feature information as search result to the set-top box 100.

The set-top box 100 plays the multimedia transmitted from the server 200. When a user inputs a request for searching an arbitrary scene-image of the playing multimedia, the set-top box 10 extracts feature information of the entire screen or partial region of the image, generates image query information for requesting image search using the extracted feature information, and transmits the image query information to the server 200. When the search result images and meta data corresponding to the image query information are provided from the server 200, the set-top box 100 browses the image and the meta data on the display apparatus 300.

Now, components of the personal-ordered multimedia data search service system having the aforementioned configuration will be described.

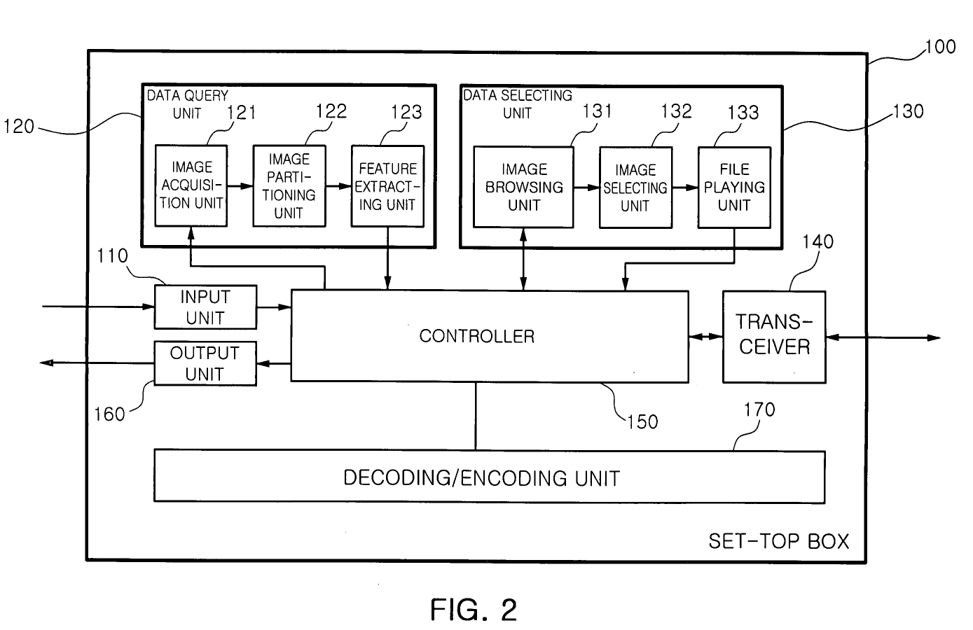

FIG. 2 is a block diagram illustrating the set-top box 100 of the personal-ordered multimedia data search service system according to the embodiment of the present invention.

As shown in FIG. 2, the set-top box 100 may includes an input unit 110, a data query unit 120, a data selecting unit 130, a transceiver 140, a controller 150, an output unit 160, and a decoding/encoding unit 170.

In the set-top box 100 having the aforementioned configuration, the input unit 110 has a function of receiving a request for searching an arbitrary scene-image input by a user during watching of a VoD, a CATV, satellite broadcasting, a terrestrial broadcasting transmitted from the remote server 200.

The data query unit 120 generates image query information of the search-requested image and transmits the image query information through the later described controller 150 and the transceiver 140 to the remote site server 200. The data selecting unit 130 browses search result images provided from the server 200 corresponding to the image query information on the display apparatus 300 of the user and, after that, plays the images selected among the browsed images by the user.

The transceiver 140 performs data communication with the remote site server 200. The controller 150 controls the components of the set-top box 100. The output unit 160 outputs the VoD, the CATV, the satellite broadcasting, the terrestrial broadcasting, the image search-requested by the user, and the search result image data provided from the server 200 on the display apparatus 300. The decoding/encoding unit 170 decodes and encodes an image data to be provided to the display apparatus 300 and a data to be provided to the remote site server 200.

The data query unit 120 includes an image acquisition unit 121, an image partitioning unit 122, and a feature extracting unit 123. The data query unit 120 may generates the image query information of the image search-requested by the user.

In the data query unit 120, the image acquisition unit 121 captures a screen of the image search-requested by the user and acquires the captured screen image or a partial region image in eh captured screen image set by the user as a searched image. When the user sets the partial region image in the captured screen image, the image acquisition unit 121 may provide a service of enabling the user to set region-partitioning points for identifying the partial region by using an interface apparatus such as a keyboard, a mouse, and a remote controller cooperatively operating with the input unit 110.

The image partitioning unit 122 is a component for partitioning the searched image, that is, the entire screen image or partial region image into object region. The image partitioning unit 122 may partition the captured entire screen or the partial region into the object region by applying a predetermined image partitioning scheme or a matching scheme of matching the region-partitioning points set by the user.

The feature extracting unit 123 extracts the feature information of the images of the object region partitioned from the searched image, that is, the image of the captured entire screen or the partial region and generates the image query information of requesting for searching the feature information including the extracted feature information. The feature information may be feature values of motions of object region or the like.

The data selecting unit 130 may include an image browsing unit 131, an image selecting unit 132, and a file playing unit 133. The image browsing unit 131 re-constructs the search result images provided from the server 200 corresponding to the image query information so as to be suitable for a configuration of the display apparatus 200 of the user. The image browsing unit 131 has a function of enabling the re-constructed search result images to be browsed through the controller 150 and the output unit 160 on the display apparatus 300.

The image selecting unit 132 checks an image selected by the user among the search result images that are re-constructed by the image browsing unit 131 and browsed on the display apparatus 300. The file playing unit 133 plays the selected image.

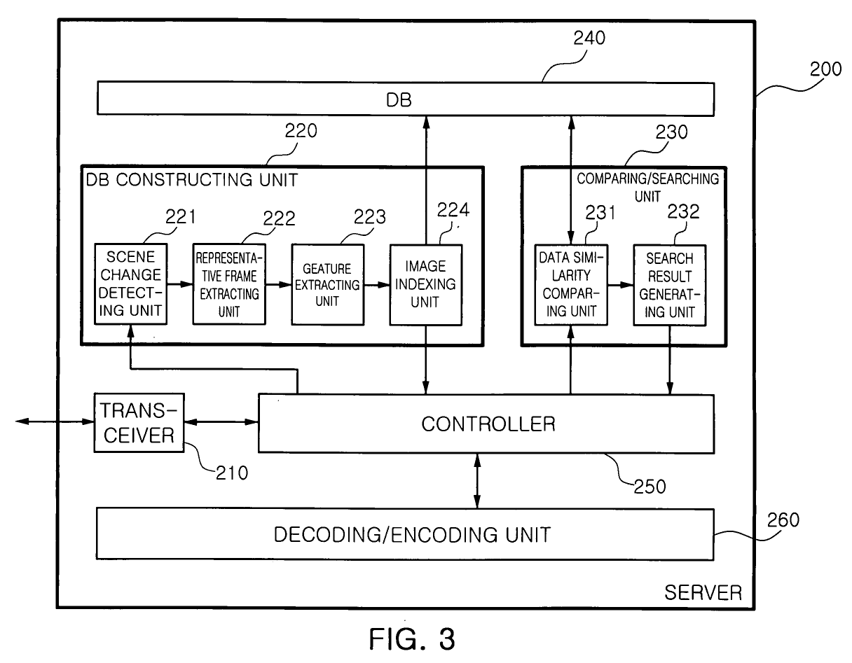

FIG. 3 is a block diagram illustrating the server 200 of the personal-ordered multimedia data search service system according to the embodiment of the present invention.

As shown in FIG. 3, in the personal-ordered multimedia data search service system, the nPVR-based server 200 may includes a transceiver 210, a DB constructing unit 220, a comparing/searching unit 230, a DB 240, a controller 250, and a decoding/encoding unit 260.

In the server 200 having the aforementioned configuration, the transceiver 210 performs data communication with the set-top box 100. The DB constructing unit 220 stores moving picture such as the VoD which the user of the set-top box 100 selects so as to be stored in the server 200 and videos newly provided from an external side in the DB 240.

When storing the moving picture such as a VoD and a video in the DB 240, the DB constructing unit 220 firstly detects scene-change boundaries and representative frames of scene-images of the to-be-stored moving picture and partitions each representative frame into a plurality of regions by using a predetermined region partitioning scheme. Next, the DB constructing unit 220 stores the representative frames and the image index information corresponding to the feature information and the meta data of the partitioned regions together with the to-be-stored moving picture in the DB 240.

The comparing/searching unit 230 checks the image query information transmitted from the set-top box 100 to acquire the feature information search-requested by the user. The comparing/searching unit 230 compares the acquired feature information of the set-top box 100 with the feature information included in the image index information of the DB 240 and searches for an image and meta data including the feature information similar to the feature information of the set-top box 100. In addition, the comparing/searching unit 230 generates search result information including the images searched from the image index information, that is, the search result images and the meta data corresponding to the images.

The controller 250 controls the components of the server 200. The decoding/encoding unit 260 decodes and encodes images transmitted and received between the server 200 and the set-top box 100.

The DB constructing unit 220 may includes a scene change detecting unit 221 which detects the scene-change boundaries between the scene-images of the moving picture and partitions the multimedia into small groups of s of the scene-images, a representative frame extracting unit 222 which extracts representative frames of the partitioned scene-images, and a feature extracting unit 223 which extracts feature information and meta data of the extracted representative frames and the regions partitioned from each representative frame, and an image indexing unit 224 which generates image indices by using the extracted feature information and meta data.

The comparing/searching unit 230 may includes a data similarity comparing unit 231 which compares the feature information acquired from the image query information transmitted from the set-top box 100 with the feature information included in the image index information of the DB 240 and a search result generating unit 232 which generates the search result information including the image and meta data of the feature information similar to the feature information acquired from the image query information as a result of the comparison.

The search result information generated by the comparing/searching unit 230 is transmitted through the controller 250 and the transceiver 210 to the set-top box 100.

Now, operations of the set-top box 100 and the server 200 having the aforementioned configurations will be described in detail with reference to accompanying drawings.

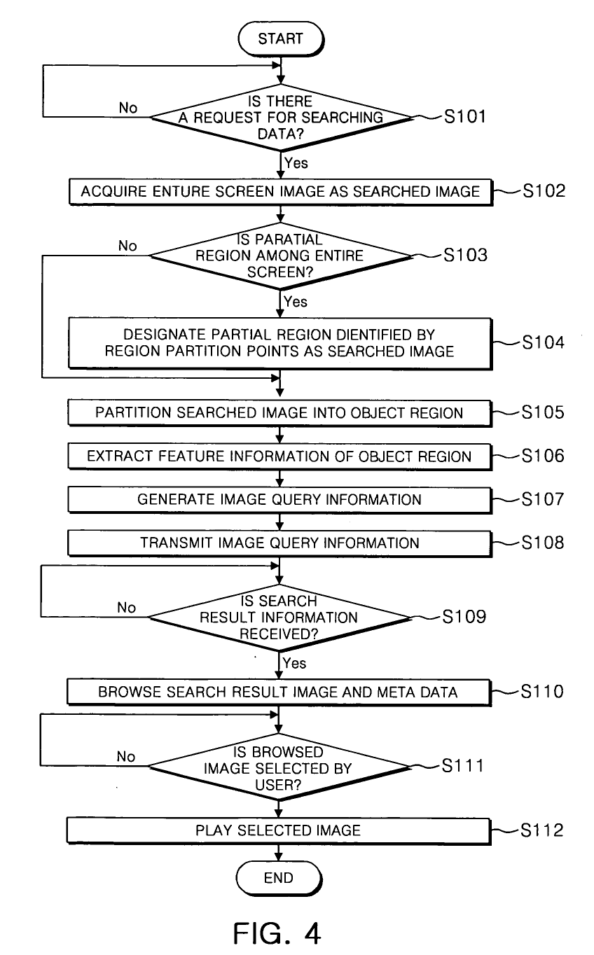

FIG. 4 is a flowchart illustrating a method of the set-top box providing a personal-ordered multimedia data search service according to an embodiment of the present invention.

Referring to FIG. 4, when the set-top box 100 receives a request for searching an image data from a user (S101), the set-top box 100 captures an image of the entire screen selected by the user and acquires the captured entire screen as a searched image (S102).

Next, the set-top box 100 determines whether or not the user is to set a partial region in the captured entire screen as a searched image (S103). If the user is to set the partial region as the search region, the set-top box 100 is input with region-partitioning points by the user and sets the partial region identified by the input region-partitioning points in the entire screen as the search region (S104). At this time, the set-top box 100 provides provide a service of enabling the user to set the region-partitioning points for identifying the partial region by using an interface apparatus such as a keyboard, a mouse, and a remote controller.

The set-top box 100 partitions the captured entire screen or the partial region into object region by applying a predetermined image partitioning scheme or a matching scheme of matching the region-partitioning points set by the user (S105).

Next, the set-top box 100 extracts feature information from the images of the partitioned object region (S106), generates image query information of requesting for searching the feature information including the extracted feature information (S107), and transmits the image query information to the server 200 (S108).

Next, when search result information corresponding to the image query information is received from the server 200 (S109), the set-top box 100 detects images and meta data included in the search result information and re-constructs the images so as to be data suitable for a configuration of the display apparatus 300 of the user and to be browsed on the display apparatus 300 (S110).

When the user checks the images and the meta data browsed on the display apparatus 300 and selects one image (S111), the set-top box 100 plays the selected image (S112).

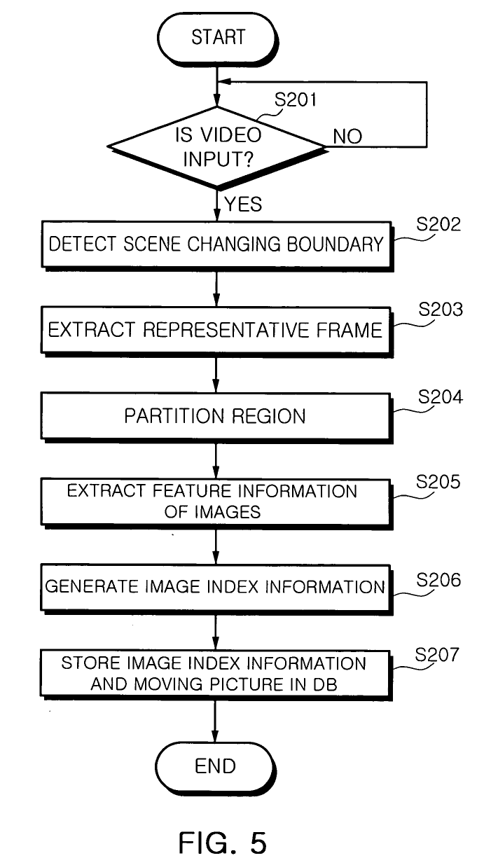

FIG. 5 is a flowchart illustrating a method of a server constructing a database providing for a personal-ordered multimedia data search service according to an embodiment of the present invention.

Referring to FIG. 5, when a VoD stored and selected by a user of a set-top box 100 or a video provided from an external side exists, the server 200 cooperatively operating with the set-top box 100 detects scene-change boundaries between image scenes of the moving picture such as the VoD and the video (S202) and extracts representative frames of the scenes partitioned by the scene-change boundary (S203).

Next, the server 200 partitions each representative frame into a plurality of regions by using a predetermined region partitioning scheme (S204) and acquires feature information and meta data from the representative frames and images of the partitioned regions (S205).

The server 200 generates image index information by using the feature information and the meta data of the representative frame and the partitioned regions (S206) and stores the generated image index information together with to-be-stored moving picture in a DB 240.

When generating the image index information, the server 200 separates information of the entire region and information of the partial region, so that the feature information of the representative frames and the feature information of the partitioned regions are included in the information of the entire region and the information of the partial region, respectively.

Accordingly, the server 200 can construct the database for providing the personal-ordered multimedia data search service.

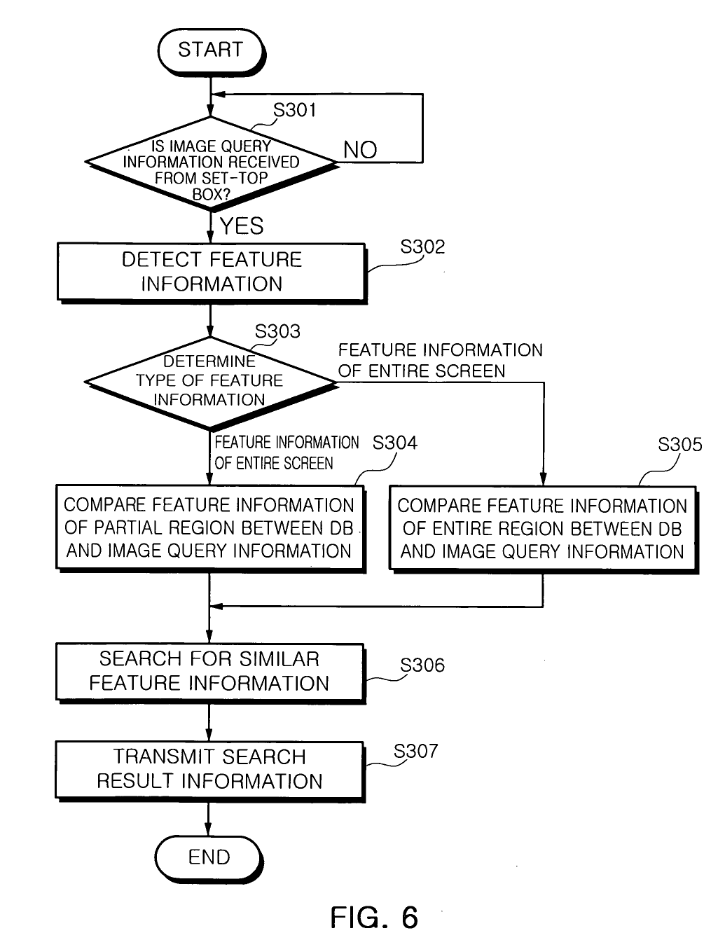

FIG. 6 is a flowchart illustrating a method of a server providing a personal-ordered multimedia data search service according to an embodiment of the present invention.

Referring to FIG. 6, when receiving the image query information from the set-top box 100 (S301), the server 200 that constructs the aforementioned database for providing the personal-ordered multimedia data search service shown in FIG. 5 detects the feature information included in the received image query information (S302).

Next, the server 200 determines whether the detected feature information is feature information of the entire screen or the partial region (S303). If the detected feature information is determined to be the feature information of the partial region, the server 200 compares the detected feature information with the feature information of the partial region partitioned from the representative frames by using the region partitioning scheme among the feature information stored in the DB 240 (S304).

If the detected feature information is determined to be the feature information of the entire screen, the server 200 compares the detected feature information with the feature information of the non-partitioned representative frames among the feature information stored in the DB 240 (S305).

When the feature information similar to the feature information detected from the image query information is searched from the DB 240 as a result of the comparison (S306), the server 200 generates search result information including the image and the meta data corresponding to the searched feature information and transmits the search result information to the set-top box 100 (S307).

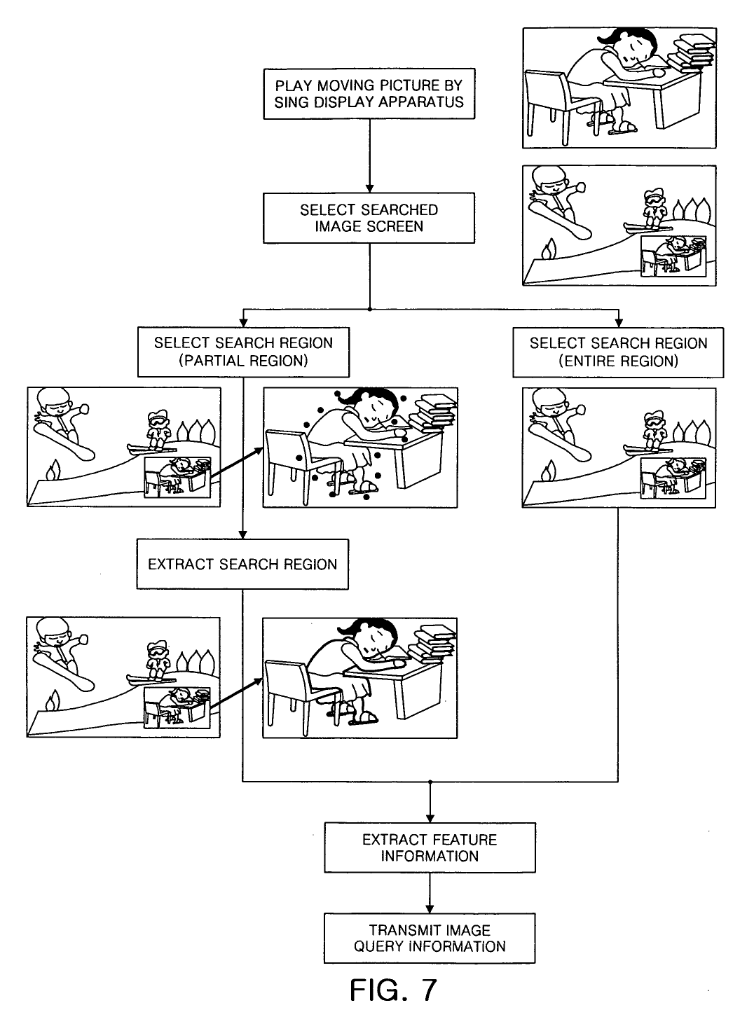

FIG. 7 is a view illustrating an image screen for personal-ordered multimedia data search service which a set-top box provides to a display apparatus, according to an embodiment of the present invention.

As shown in FIG. 7, the set-top box 100 may be input with a request for searching an arbitrary scene-image screen of a moving picture when the moving picture such as a VoD, a CATV, satellite broadcasting, or a terrestrial broadcasting is played on the display apparatus 300 of the user (a). In this case, if a user's desired screen is displayed during the watching of the moving picture, the user can request for searching the image screen by pushing an input button, for example, ‘search query’.

Next, the set-top box 100 may capture the entire screen including the search-requested image screen and display a small-sized image in a lower portion of the playing moving picture (b). In this case, the watching VoD image is continuously played on the screen of the display apparatus 300.

Next, the set-top box 100 provides a user which desires to set a partial region of the entire captured screen as a searched image instead of the entire captured screen a service of enabling the user to input region-partitioning points by using an interface apparatus such as a keyboard, a mouse, and a remote controller. Next, the set-top box 100 is input with the region-partitioning points for identifying the partial region in the entire screen (c).

The set-top box 100 partitions the search region of the captured entire screen or the partial region into object region by using a predetermined image partitioning scheme or a matching scheme of matching the region-partitioning points set by the user (d and e) and extracts feature information from the partitioned object region (f). When the feature information is extracted, the set-top box 100 transmits image query information for requesting for the feature information including the extracted feature information to the server 200 (g).

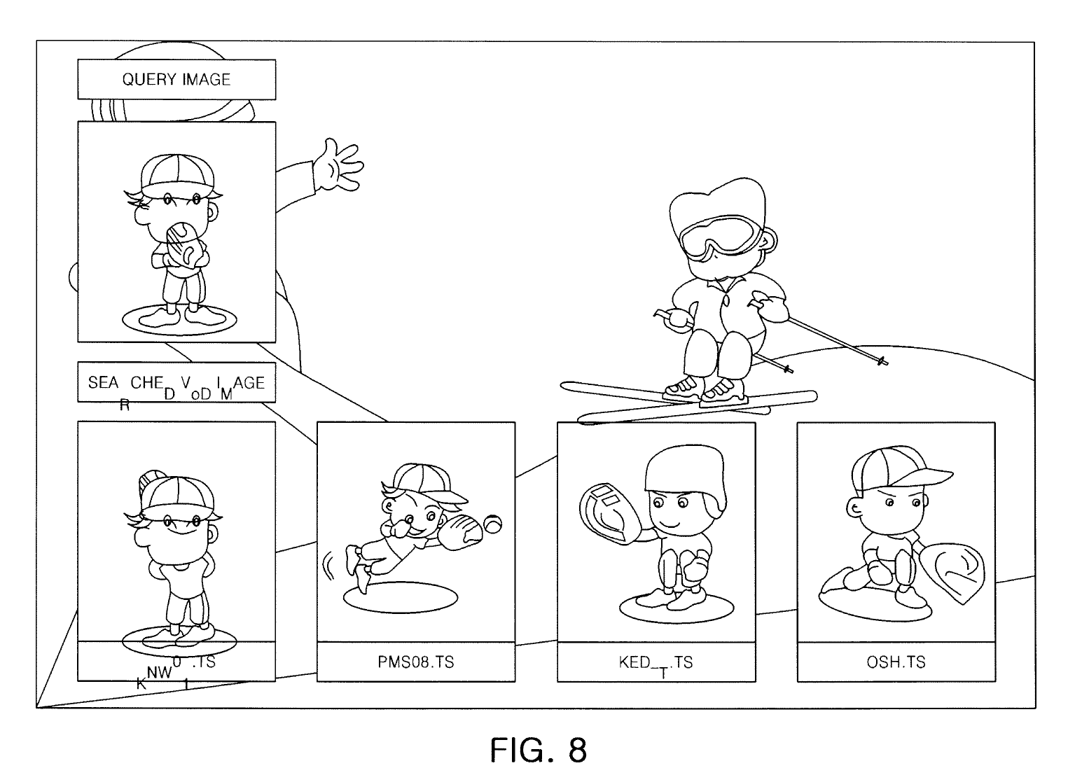

FIG. 8 is a view illustrating a screen of a display apparatus on which search result images and meta data provided from a sever is browsed according to an embodiment of the present invention.

As shown in FIG. 8, the set-top box 100 browses the searched image search-requested by the user and the search result images and the meta data provided from the server 200 on the currently-watching moving picture screen, so that the user can check the searched image, the search result image, and the meta data and select to-be-played search result images.

As described above, according to a personal-ordered multimedia data search service method and apparatuses thereof of the present invention, a user can easily search for multimedia data in a configuration of a set-top box, so that it is possible to reduce a search time for the multimedia data and to maximize user's satisfaction.

In addition, according to a personal-ordered multimedia data search service method and apparatuses thereof of eh present invention, searching for an entire image, a text, and a partial image, that is, an object image included in the entire image can be supported in a configuration of the set-top box, so that it is possible to provide more convenient search configuration to the user and to improve performance in searching.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A set-top box for providing a personal-ordered multimedia data search service comprising:
a data query unit which, if a user requests for searching an arbitrary scene-image during playing of multimedia, extracts feature information of the entire screen or partial region of the scene-image and generates image query information of requesting for searching an image by using the extracted feature information;
a data selecting unit which browses search result images and meta data provided from a server corresponding to the image query information on a display apparatus, and plays the one image selected by the user among the browsed images; and
a transceiver which communicates data with the server to transmit the image query information and receive the search result images and the meta data.

2. The set-top box of claim 1, wherein the data query unit comprises:
an image acquisition unit which captures the entire screen of the image search-requested by the user and acquires an image of the captured entire screen or partial region of the captured entire screen as searched images;
an image partitioning unit which partitions the entire screen or the partial region into object regions; and
a feature extracting unit which extracts the feature information from the object regions and generates the image query information including the extracted feature information.

3. The set-top box of claim 2, wherein the feature information includes feature values of motions of object regions or the like.

4. The set-top box of claim 2, wherein the image acquisition unit provides a service of enabling the user to set region-partitioning points for identifying the partial region by using an interface apparatus, when the user acquires the partial region image in the captured screen image.

5. The set-top box of claim 2, wherein the image partitioning unit partitions the entire screen or the partial region into the object regions by using a predetermined image partitioning scheme or a matching scheme for region-partitioning points set by the user.

6. The set-top box of claim 1, wherein the data selecting unit comprises:
an image browsing unit which re-constructs the search result images and the meta data provided from the server corresponding to the image query information to be data suitable for a configuration of the display apparatus and browses the search result images and the meta data on the display apparatus;
an image selecting unit which checks an image selected by the user among the browsed images on the display apparatus; and
a file playing unit which plays the image selected by the user.

7. A server for providing a personal-ordered multimedia data search service comprises:
a DB (database) which stores at least one multimedia and image index information on each scene-image of the multimedia;
a DB constructing unit which detects scene-change boundaries and representative frames of scene-images of the multimedia and partitions each representative frame of the scene-images into a plurality of regions by using a predetermined region partitioning scheme, and extracts feature information and meta data from the representative frames and the partitioned regions to generate the image index information;
a comparing/searching unit which, when the image query information is transmitted, acquires the image index information having the feature information included in the image query information by searching the DB and generates search result information including search result images and meta data based on the searched feature information; and
a transceiver which communicates data with an external device to receive the image query information and transmit the search result information.

8. The server for providing a personal-ordered multimedia data search service of claim 7, wherein the DB constructing unit comprises:
a scene change detecting unit which detects the scene-change boundaries between the images of the multimedia to partition the multimedia into small sized meaning groups of scene-images;
a representative frame extracting unit which extracts the representative frames of the partitioned scene-images;
a feature extracting unit which extracts the feature information and the meta data of the representative frames and the regions partitioned from the representative frames; and
an image indexing unit which generates the image index information by using the feature information and the meta data.

9. The server for providing a personal-ordered multimedia data search service of claim 8, wherein the feature extracting unit sets the feature information of the representative frame of each scene-image as entire-region feature information and sets the feature information of the regions partitioned from the representative frame as partial-region feature information to generate and store the image index information in separation of the entire region and the partial regions.

10. The server for providing a personal-ordered multimedia data search service of claim 7, wherein the comparing/searching unit comprises:
a data similarity comparing unit which compares the feature information of the image query information with the feature information of the image index information; and
a search result generating unit which searches for the feature information of the image index information that is determined to be similar to the feature information of the image query information and generates the search result information including the search result images and the meta data corresponding to each of the searched feature information of the image index information.

11. A personal-ordered multimedia data search service system, comprising:
a server which extracts feature information and meta data of entire screen or partial region of each scene-image of multimedia to generate image index information and then obtains and provides search result images and meta data having feature information similar to feature information of image query information by searching the image index information, when image query information is received; and
a set-top box which, if when a request for searching a specific image is detected during playing of multimedia, extracts feature information of the specific image to generate the image query information, transmits the image query information to the server, and after that, and browses the search result images and the meta data transmitted from the server on a display apparatus.

12. The personal-ordered multimedia data search service system of claim 11, wherein the set-top box comprises:
a data query unit which, if a requests for searching an arbitrary scene-image during playing of multimedia is received, extracts the feature information of the entire screen or partial region of the arbitrary scene-image and generates the image query information of requesting for searching an image by using the extracted feature information;
a data selecting unit which browses search result images and meta data provided from a server corresponding to the image query information on the display apparatus, and play one image selected by a user among the browsed images; and
a transceiver which transmits the image query information to the server and receives the search result images and the meta data transmitted from the server to transfer the search result images and the meta data to the data selecting unit.

13. The personal-ordered multimedia data search service system of claim 11, wherein the server comprises:
a DB (database) which stores the multimedia and the image index information on each scene-image of the multimedia;
a DB constructing unit which extracts the feature information and the meta data from the entire screen or the partial regions of each scene-image of the multimedia to generate the image index information;
a comparing/searching unit which, if the image query information is transmitted from the set-top box, acquires the image index information having the feature information included in the image query information by searching the DB and generates search result information including the search result images and the meta data based on the searched feature information; and
a transceiver which communicates data with the set-top box to receive the image query information and transmit the search result information to an external apparatus.

14. A method of operating a set-top box for providing a personal-ordered multimedia data search service comprising steps of:
extracting feature information of the entire screen or partial region of an arbitrary scene-image, when a request for searching the arbitrary scene-image during playing of multimedia is received;
generating image query information of requesting for searching an image by using the extracted feature information and transmitting the image query information to the server; and
browsing search result images and meta data on a display apparatus, when the search result images and the meta data corresponding to the image query information are received.

15. The method of claim 14, wherein the step of extracting comprises steps of:
capturing the entire screen of the arbitrary scene-image requested for searching;
checking whether the partial region in the entire screen is set or not;
setting the partial region as an searched image if the partial region is set and setting the entire screen as the searched image if not;
partitioning the searched image into object regions; and
extracting the feature information of the object regions.

16. The method of claim 15, wherein the step of checking provides a setting environment of region-partitioning points for partitioning the partial region from the entire screen to a user in order to set the partial region.

17. The method of claim 15, wherein the step of partitioning detects the object region from the entire screen or the partial region by using a predetermined image partitioning scheme or a matching scheme for region-partitioning points set by the user.

18. The method of claim 14, wherein the step of browsing re-constructs the search result images and the meta data to be data suitable for a configuration of the display apparatus and browses the search result images and the meta data on the display apparatus.

19. The method of claim 14 further comprising;
capturing the entire screen of the arbitrary scene-image and displaying the captured screen on a lower region of real-time playing multimedia, when a request for searching the arbitrary scene-image is received; and
further displaying a setting environment of region-partitioning points for partitioning the partial region on the lower region.

20. The method of claim 14 further comprising;
detecting whether one image is selected or not after browsing the search result images and the meta data on the display apparatus; and
playing a selected image using the display apparatus, when the one image is selected.

21. A method of operating a server for providing a personal-ordered multimedia data search service comprising steps of;
extracting feature information and meta data from the entire screen or partial regions of each screen-image of multimedia and generating and storing image index information of each scene-image;
receiving an image query information transmitted from an external device and then checking feature information included in the image query information; and
searching feature information similar to feature information included in the image query information from the image index information, generating search result information including search result images and meta data corresponding to the searched feature information, and transmitting the search result information to the external device.

22. The method claim 21, wherein the step of generating and storing comprising steps of;
detecting scene-change boundaries between images of the to multimedia to partition the multimedia into scene-images;
extracting representative frames of the partitioned scene-images and the feature information and the meta data of regions obtained by partitioning each representative frame by using a predetermined region partitioning scheme; and
generating and storing the image index information by using the extracted feature information and meta data.

23. The operating method of server for providing a personal-ordered multimedia data search service of claim 22, wherein the feature information of the representative frame of each scene-image is set as entire-region feature information, and the feature information of the regions partitioned from the representative frame is set as partial-region feature information, so that the image index information is separated into the entire region and the partial regions.

24. The method of claim 23, wherein the step of searching feature information similar to feature information included in the image query information from the image index information comprising;
determining whether the arbitrary feature information is feature information of the entire screen or the partial regions; and
searching for image index information of the entire region or the partial regions according to whether the feature information is feature information of the entire screen or the partial region so as to search for the feature information similar to the extracted feature information.
